(19) United States
(12) Patent Application Publication
(10) Pub. No.: US 2016/0361960 A1
(43) Pub. Date: Dec. 15, 2016

(54) WALL MOUNT TRAILER HITCH

(71) Applicant: DOUGLAS WRIGHT, EASLEY (SC)

(72) Inventor: DOUGLAS WRIGHT, EASLEY (SC)

(73) Assignee: THE WRIGHT SUN DEE COMPANY, LLC, PIEDMONT, SC (US)

(21) Appl. No.: 14/736,676

(22) Filed: Jun. 11, 2015

(51) Int. Cl. B60D 1/48; B62H 3/00; F16M 13/02

(52) U.S. Cl. CPC B60D 1/48; F16M 13/02; B62H 3/00

(57) ABSTRACT

A wall mount trailer hitch for securing a trailer in a substantially flat position when not in use and related systems and methods are disclosed. The wall mount trailer hitch includes a planar base plate member having a means for securing the base plate member to a wall. The wall mount trailer hitch further includes a hitch receiver member projecting outward from the base plate member and away from the wall. The hitch receiver can be engaged with a hitch member, such as a ball mount insert, a pintle mount or other hitch that can be mated with the coupling device of a trailer. The wall mount trailer hitch can be vertically positioned to secure a trailer, and in particular a single-axle trailer, in a substantially level position.

### CROSS-REFERENCE TO RELATED APPLICATIONS

N/A

### FIELD OF THE INVENTION

This invention relates generally to the art of single axle trailers and more particularly to the storage thereof.

### BACKGROUND

The present invention discloses a wall mount trailer hitch and more particularly a trailer hitch that can be mounted to a wall to enable a trailer to be secured and stored in a flat position.

Trailers and, in particular, single-axle trailers are often unstable, unsecure and unable to safely store goods and other possessions when they are unhitched from a tow vehicle. For example, most single-axle utility trailers are stored with their bed or cargo compartment in an unlevel position because the trailer is designed for the tongue and hitch-coupling device to be above ground-level when engaged with the hitch of a towing vehicle. Other devices, such as the use of metal bars or cinder blocks, have been used to raise the tongue of a trailer when the trailer is stored, but these devices fail to fully secure the trailer and prevent it from moving. Without raising the tongue, a single-axle trailer cannot be stored in a garage or other storage facility without wasting space that otherwise could be used to store various goods and possessions. The present invention recognizes these problems by, among other things, securing a trailer in a substantially flat position that provides additional storage in the bed or cargo compartment of the trailer.

### SUMMARY

The present invention includes a wall mount trailer hitch for securing a trailer in a substantially flat position when not in use. In one embodiment of the invention, the wall mount trailer hitch includes a planar base plate member having a means for securing the base plate member to a wall, such as through holes and screws that can be drilled into the studs of the wall. The wall mount trailer hitch further includes a hitch receiver member projecting outward from the base plate member away from the wall. The hitch receiver member can be engaged with a hitch member, such as a ball mount insert, a pintle mount or other hitch that can be mated with the coupling device of a trailer.

In one embodiment, the height of the hitch member of the wall mount trailer hitch is vertically positioned to secure a single-axle trailer in a substantially level position.

In one embodiment, the base plate member is oriented in a substantially vertical position such that it can be secured to the wall by multiple screws or other fasteners that are attached to one wall stud via various holes through the base plate member. In an alternative embodiment, the base plate member is oriented in a substantially horizontal position such that it can be secured to the wall by multiple screws or other fasteners that are attached to more than one wall stud, wherein at least two of the screws or other fasteners run through oblong holes in the base plate member.

Another embodiment of the present invention includes a wall mount trailer hitch system that includes a building wall member and a planar base plate member having a means for securing the base plate member to the building wall member. This embodiment also includes a hitch receiver member projecting from the base plate member, a hitch member engaged with the hitch receiver member, and a trailer having and a coupling device wherein the coupling device is engaged with the hitch member.

In one embodiment of the wall mount trailer hitch system, the hitch member of the wall mount trailer hitch system is vertically positioned to secure a single-axle trailer in a substantially level position.

In one embodiment of the wall mount trailer hitch system, the base plate member is oriented in a substantially vertical position such that it can be secured to the wall through multiple screws or other fasteners that are attached to one wall stud via various holes through the base plate member. In an alternative embodiment of the wall mount trailer hitch system, the base plate member is oriented in a substantially horizontal position such that it can be secured to the wall by multiple screws or other fasteners that are attached to more than one wall stud, wherein at least two of the screws or other fasteners run through oblong holes in the base plate member.

Another embodiment of the present invention includes a method for securing a single-axle trailer to a wall that includes securing a wall mount trailer hitch to a building wall member. The method also includes adjusting the height of the wall mount trailer hitch to secure the trailer in a substantially level position and engaging a coupling device on the trailer with the wall mount trailer hitch.

### BRIEF DESCRIPTION OF THE DRAWINGS

FIG. 1 is a perspective view of an embodiment of the wall mount trailer hitch system of the present invention;

FIG. 2 is a perspective assembly view of the FIG. 1 embodiment of the wall mount trailer hitch of the present invention;

FIG. 3 is a side elevation view of the FIG. 2 embodiment;

FIG. 4 is a front elevation view of the wall mount of another embodiment of the wall mount trailer hitch of the present invention;

FIG. 5 is a side elevation view of another embodiment.

### DETAILED DESCRIPTION OF REPRESENTATIVE EMBODIMENTS

The present invention is related to a wall mount trailer hitch that is particularly suitable for use for securing a trailer in a substantially flat position when it is not in use. Although primarily described herein in terms of its use with single-axle trailers, it will be clear that the wall mount trailer hitch may be used in connection with all types of trailers. The invention will be described with reference to the figures, which are an integral non-limiting component of the invention. Throughout the description similar elements will be numbered accordingly.

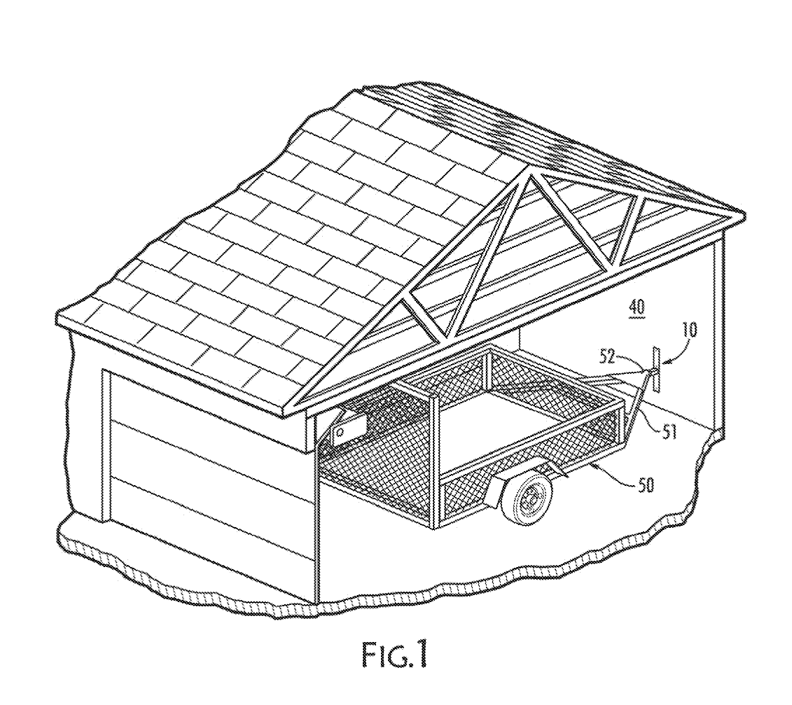

FIG. 1 illustrates an embodiment of the wall mount trailer hitch 10 of the present invention. The wall mount trailer hitch may be composed of steel or other rigid materials with sufficient strength to support the tongue weight of a trailer. In this embodiment, the wall mount trailer hitch 10 is secured to a wall 40 of a garage. It will be understood that the wall mount trailer hitch may be used with many different types of wall structures and buildings so as to render the trailer bed stable and horizontal. As shown in FIG. 1, the wall mount trailer hitch 10 is engaged with the coupling device 52 of a trailer 50, which is affixed to the distal end of the tongue 51 of the trailer 50. The wall mount trailer hitch 10 is vertically positioned on the wall 40 such that the trailer 50 is secured with its bed in a substantially level position.

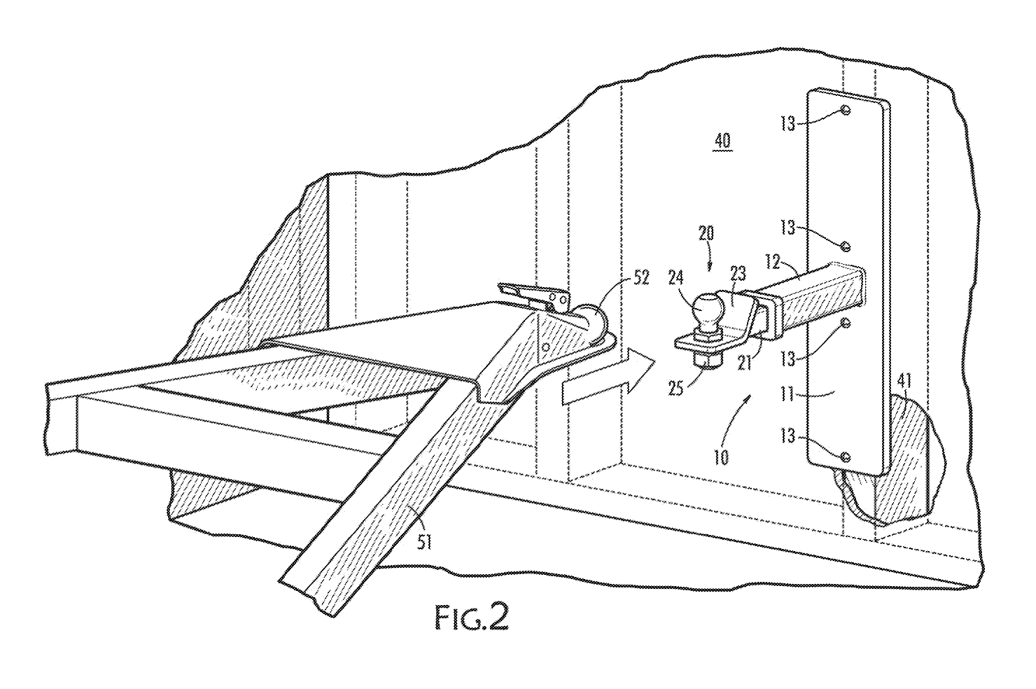

FIG. 2 illustrates an embodiment of the present invention where the coupling device 52 of a trailer 50 is about to be engaged with the wall mount trailer hitch 10. More specifically, FIG. 2 illustrates the wall mount plate 11 of the wall mount trailer hitch 10 secured to the wall stud 41 of a wall 40. While the wall mount plate 11 as shown in FIG. 2 is configured in a vertical position, the wall mount plate 11 may be configured in other directions as desired. The wall mount plate 11 is secured to the wall stud 41 with screws that run through multiple through holes 13 in the wall mount plate 11. The wall mount plate 11 is approximately four inches wide, twenty-four inches long and three-eighths inches thick with through holes 13 of approximately three-eighths-inch-diameters located at approximately one and one-half inches and nine and one-fourth inches from both the top and bottom of the wall mount plate 11, although these dimensions can vary depending on the embodiment. The wall mount trailer hitch 10 also has a hitch receiver member 12 that projects from the front of the wall mount plate 11. The hitch receiver member 12 can receive multiple types of trailer hitches, such as a ball mount, pintle mount, bike rake or other hitches designed to mate with the coupling device of a trailer.

In FIG. 2, the hitch receiver member 12 is engaged with a drawbar 21 of a ball mount insert 20. The ball mount insert 20 also includes a bracket 23 that attaches to the drawbar 21 and a ball mount 24, which is attached to the bracket 23 using a nut 25. The ball mount 24 is configured to receive a coupling device 52 that is attached to the distal end of the tongue 51 of trailer 50.

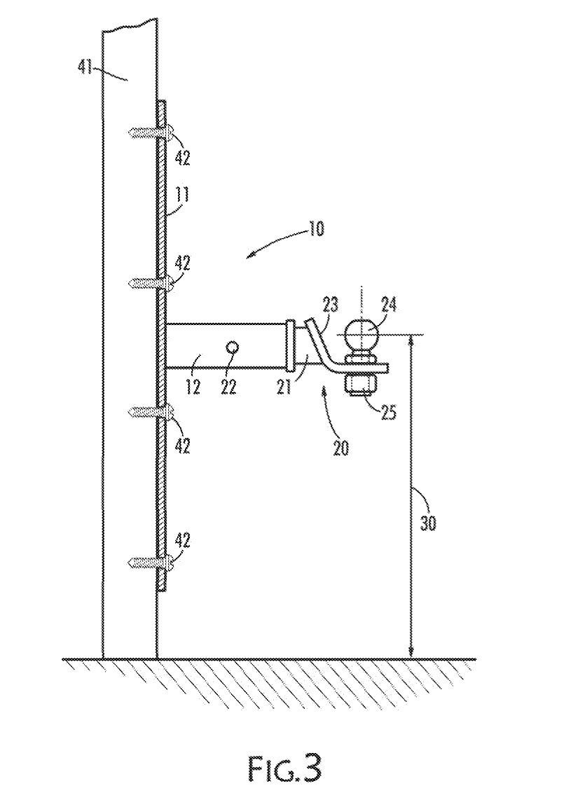

FIG. 3 is a side elevation view of the wall mount trailer hitch of FIGS. 1 and 10. In FIG. 3, the wall mount plate 11 is secured to the wall stud 41 of a wall 40 using screws 42 that run through four through holes 13 in the wall mount plate 11. While many different means to secure the wall mount plate 11 to the wall 40 can be used, this embodiment includes four five-sixteenth-inch by three-inch wood screws. The hitch receiver member 12 is shown projecting from the face of the wall mount plate 11. The hitch receiver member 12 includes a pin hole 22 that is configured to receive a securing pin to secure the drawbar 21 of the ball mount insert 20 and allows the ball mount insert 20 to be removed and replaced with other types of inserts as desired.

In FIG. 2, the drawbar 21 of the ball mount insert 20 is inserted into the hitch receiver member 12. The ball mount 24 is attached to the drawbar 21 of the ball mount insert 20 using a bracket 23 and a nut 25. The ball height 30, which is the distance between the center of the ball mount 24 and ground-level, can be adjusted by moving the wall mount trailer hitch 10 or various components thereof in a vertical direction to secure a trailer 50 in a substantially level position when the coupling device 52 of the trailer 50 is engaged with the ball mount 24.

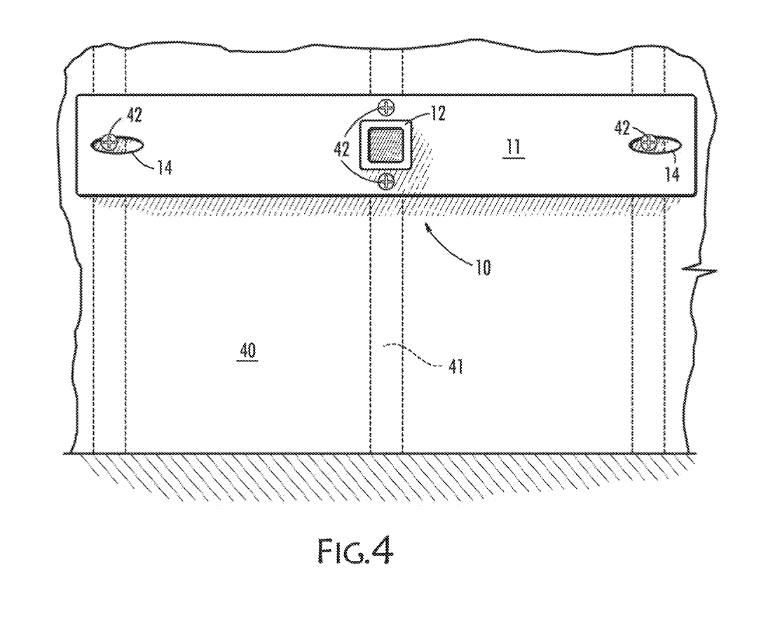

FIG. 4 illustrates a front elevation view of an embodiment of the wall mount trailer hitch 10 without a receiver hitch insert engaged with the hitch receiver 12. In the embodiment shown in FIG. 4, the wall mount plate 11 is oriented in a generally horizontal position, such that it can be secured to multiple wall studs 41 of a wall 40. The wall mount plate 11 contains a round through hole directly above and a round through hole directly below the hitch receiver member 12 and oblong through holes 14 located near the left and right ends of the wall mount plate 11. FIG. 4 shows screws 42 running through each of the through holes and engaged with three of the wall studs 41 in the wall 40. In this embodiment, the wall mount plate 11 is approximately thirty-six inches wide, four inches tall and three-eighths inches thick with round through holes 13 approximately three-eighths inches in diameter located directly above and below the hitch receiver and approximately three-inch long oblong through holes 14 approximately one inch from the left side and one inch from the right side of the wall mount plate 11, although these dimensions can vary depending on the embodiment. FIG. 4 also shows a cross-section of the hitch receiver member 12 that is projecting toward the viewer of the figure, wherein the hitch receiver member 12 is capable of receiving various types of inserts.

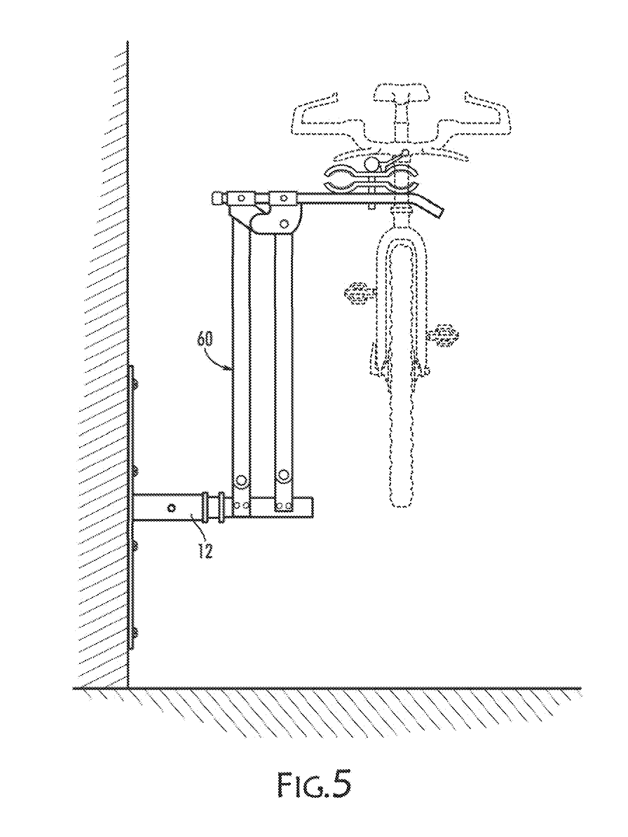

FIG. 5 illustrates an alternative embodiment whereby the hitch receiver 12 is utilized for storage of other devices such as bicycle rack 60 normally associated for use with a moving vehicle.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. For example, several configurations with modified shapes, sizes, and dimension of the features of the wall mount trailer hitch are suitable for the design of the present invention. Likewise, other configurations altering the number of parts, attachment positions of the parts, means for attaching and securing the parts could be employed to demonstrate the invention and are intended to be encompassed by the present invention. Thus, the present invention should not be limited by the description or any of the above described exemplary embodiments.

In addition, it should be understood that the figures, which highlight the functionality and advantages of the present invention, are presented for purposes of example only. The architecture of the present invention is sufficiently flexible and configurable, such that it may be used in ways other than that shown in the accompanying figures.

1. A wall mount trailer hitch comprising:
a planar base plate member having a means for securing the base plate member to a wall;
a hitch receiver member projecting from the base plate member; and
a hitch member for receiving a hitch coupling device of a trailer, wherein the hitch member is engaged with the hitch receiver member and wherein the trailer once hitched is stored in a substantially horizontal state.

2. The wall mount trailer hitch of claim 1 wherein the height of said hitch member is vertically positioned to secure the trailer in a substantially level position.

3. The wall mount trailer hitch of claim 2 wherein the trailer is a single-axle trailer.

4. The wall mount trailer hitch of claim 2 wherein the means for securing the base plate member to a wall comprises a plurality of holes through the base plate member so configured to allow screws to run through the base plate member and engage a structural stud in the wall.

5. The wall mount trailer hitch of claim 2 wherein the means for securing the base plate member to a wall comprises a plurality of holes through the planar base plate member so configured to allow screws to run through the planar base plate member and engage more than one structural stud in the wall.

6. The wall mount trailer hitch of claim 5 wherein at least two of the plurality of holes are oblong.

7. A wall mount trailer hitch system comprising:
a building wall member;
a planar base plate member secured to the building wall member;
a hitch receiver member projecting from the base plate member;
a hitch member engaged with the hitch receiver member; and
a trailer having and a coupling device wherein the coupling device is engaged with the hitch member.

8. The wall mount trailer hitch system of claim 7 wherein the height of said hitch member is vertically positioned to secure the trailer in a substantially level position.

9. The wall mount trailer hitch system of claim 8 wherein the trailer is a single-axle trailer.

10. A method for securing a trailer to a wall comprising:
(a) securing a wall mount trailer hitch to a building wall member;
(b) adjusting the height of the wall mount trailer hitch to secure the trailer in a substantially level position; and
(c) engaging a coupling device on the trailer with the wall mount trailer hitch.

11. The method of claim 10, wherein the trailer is a single-axle trailer.

12. A wall mount apparatus comprising:
a planer base plate member having means for securing the base plate to a stationary interior wall;
a hitch receiving member projecting from the base plate; and, a hitch member for receiving a hitch coupling device of an item for secure storage within said interior space.

13. The wall mount device of claim 12 wherein the stored item is a bicycle rack.
